(19) United States
(12) Patent Application Publication
(10) Pub. No.: US 2017/0169329 A1
(43) Pub. Date: Jun. 15, 2017

(54) SERVER, SYSTEM AND SEARCH METHOD

(71) Applicant: KABUSHIKI KAISHA TOSHIBA, Minato-ku Tokyo (JP)

(72) Inventors: Kenichi Doniwa, Asaka Saitama (JP); Kosuke Haruki, Tachikawa Tokyo (JP); Masahiro Ozawa, Akishima Tokyo (JP)

(21) Appl. No.: 15/214,380

(22) Filed: Jul. 19, 2016

(30) Foreign Application Priority Data
Dec. 15, 2015 (JP) 2015-244307

(51) Int. Cl. G06N 3/08; G06F 17/30; H04L 29/08; G06N 7/00

(52) U.S. Cl. CPC G06N 3/08; G06N 7/005; G06F 17/30864; H04L 67/1002

(57) ABSTRACT

According to one embodiment, a server is included in a system which also includes a second server and a third server. The server also configured to specify, from a search range of the parameters, a first combination of first initial parameters and a second combination of second initial parameters, using a search method based on a uniform distribution, and to specify, from a search range of the parameters, a third combination of third parameters, based on the first and second learning results and using a search method based on a probability distribution.

### CROSS-REFERENCE TO RELATED APPLICATIONS

This application is based upon and claims the benefit of priority from Japanese Patent Application No. 2015-244307, filed Dec. 15, 2015, the entire contents of which are incorporated herein by reference.

### FIELD

Embodiments described herein relate generally to a server, a system and a search method.

### BACKGROUND

In the field of image and voice recognition, recognition performance has been gradually enhanced using mechanical learning, such as a support vector machine (SVM). Further, in recent years, multilayer neural networks have been employed, which significantly enhances recognition performance. Particular attention has been paid to a deep learning technique using the multilayer neural network, and the deep learning technique is now also applied to a field of, for example, natural language analysis, as well as image and voice recognition.

However, the deep learning technique requires a vast number of calculations for learning, and hence requires a lot of time. Further, in deep learning, many hyper-parameters (parameters that define learning operations), such as the number of nodes in each layer, the number of layers, the rate of learning, etc., are used. Furthermore, depending on values of hyper-parameters, recognition performance greatly varies. Accordingly, it is necessary to search for a combination of hyper-parameters that provides best recognition performance. In the search for hyper-parameter combinations, a method is adopted in which learning is performed while changing the combination of hyper-parameters, and a combination for realizing best recognition performance is selected from learning results based on respective combinations.

In the above-mentioned deep learning, the conventional search method of selecting an optimal combination of hyper-parameters (for obtaining good recognition performance) from a large number of parameters requires a lot of time, since the total of parameter combinations is enormous.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a specific configuration of a hyper-parameter search system according to an embodiment.

FIG. 2 is a block diagram showing a specific configuration of a server used in the system of FIG. 1.

FIG. 3 is a block diagram s showing a specific configuration of a manager used in the system of FIG. 1.

FIG. 4 is a view showing the hierarchical structure of the system shown in FIG. 1 and examples of hyper-parameters.

FIG. 5 is a flowchart showing processing performed by the manager of the system shown in FIG. 1.

FIG. 6 is a flowchart showing processing performed by a worker of the system shown in FIG. 1.

FIG. 7 is a flowchart showing processing performed when the worker in the system shown in FIG. 1 includes an interrupt function.

### DETAILED DESCRIPTION

Various embodiments will be described hereinafter with reference to the accompanying drawings. In general, according to one embodiment, a server configured to construct a neural network for performing deep learning, and to search for parameters defining a learning operation, the server, a second server and a third server included in a system, the server also configured to specify, from a search range of the parameters, a first combination of first initial parameters and a second combination of second initial parameters, using a search method based on a uniform distribution; transmit the first combination of first initial parameters to the second server; transmit the second combination of second initial parameters to the third server; receive, from the second server, a first learning result based on the first combination of first initial parameters; receive, from the third server, a second learning result based on the second combination of second initial parameters; specify, from the aearch range of the parameters, a third combination of third parameters, based on the first and second learning results and using a search method based on a probability distribution; transmit the third combination of third parameters to the second or third server; and receive, from the second or third server, a third learning result based on the third combination of third parameters.

Embodiments will be described hereinafter with reference to the accompanying drawings.

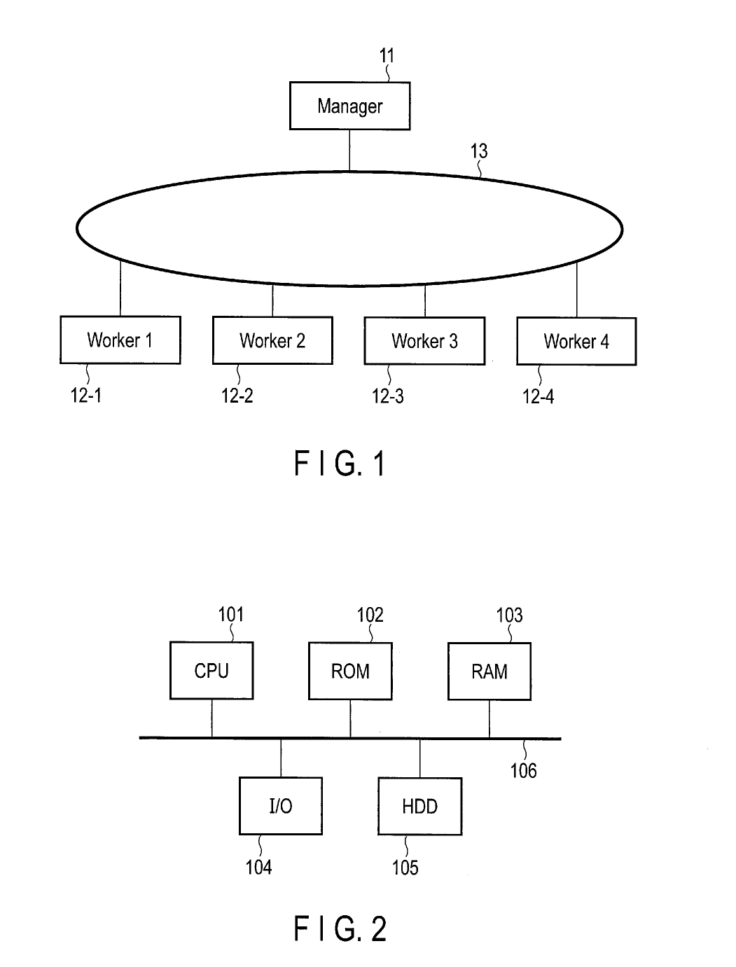

FIG. 1 is a block diagram showing a specific configuration of a hyper-parameter search system according to the embodiment. This system is a server system of a cluster configuration, wherein a server (hereinafter, referred to as a manager) 11 called a manager, and a plurality (four in the embodiment) of servers (hereinafter, referred to as workers) 12-i (i is any one of 1 to 4), are connected to a network 13. The system constructs a multilayer neural network for executing deep learning.

As shown in FIG. 2, servers used as the manager 11 and workers 12-i each comprise a central processing unit (CPU) 101 for executing programs for control, a read-only memory (ROM) 102 storing the programs, a random access memory (RAM) 103 for providing a workspace, an input/output (I/O) unit 104 for receiving and outputting data from and to the network, a hard disk drive (HDD) 105 storing various types of data, and a bus 106 connecting them to each other.

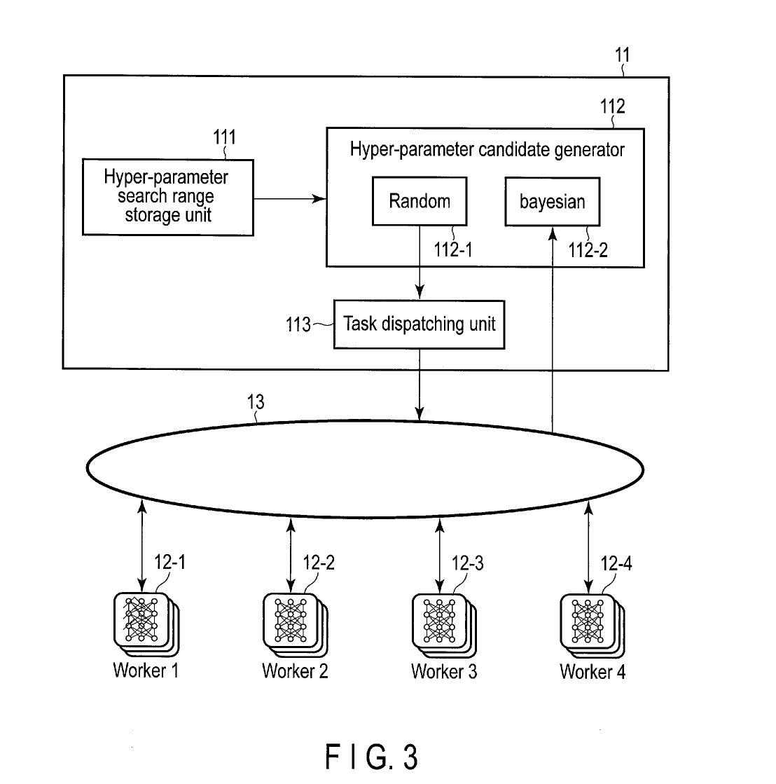

The manager 11 is a server for managing hyper-parameter search processing, and comprises a hyper-parameter search range storage unit 111, a hyper-parameter candidate generator 112, and a task dispatching unit 113, as specifically shown in FIG. 3. The hyper-parameter search range storage unit 111 stores data on the search ranges of hyper-parameters pre-used by deep learning. The hyper-parameter candidate generator 112 sequentially reads search ranges from the hyper-parameter search range storage unit 111, and generates candidates for combinations of hyper-parameters to be searched for within the read search ranges and values to be allocated to the respective hyper-parameters. At this time, if having received learning results from respective workers 12-i, the hyper-parameter search range storage unit 111 reflects the learning results in generation of candidates for hyper-parameter combinations. As methods for candidate generation, it is assumed here that a random method (112-1) and a Bayesian method (112-2) are prepared.

The random system is a search system based on a uniform distribution, and excels in a discrete parameter search and a search independent of an initial value. The Bayesian method is a type of gradient method, and is a search method based on a probability distribution. It is configured to search for an optimal solution in the vicinity of values obtained by past searches, and excels in searching for sequential parameters. Regarding particulars of the Bayesian method, the following discloses an open-source hyper-parameter search environment based on a Bayesian search, and processing including processing of distributing tasks to a plurality of servers:

A treatise: Practical Bayesian Optimization of Machine Learning Algorithms

(http://papers.nips.cc/paper/4522-practical-bayesian-optimization-of-machine-learning-algorithms.pdf)

Open-source environment: Spearmint (https://github.com/JasperSnoek/spearmint) Latest commit 0544113 on Oct. 31, 2014

The above-described task dispatching unit 113 distributes, as tasks to workers 12-i, learning processing of respective candidates generated by the hyper-parameter candidate generator 112, thereby instructing learning.

In contrast, workers 12-i receive, from the manager 11, candidates of combinations of hyper-parameters, perform learning associated with the received candidates, and sends results of learning, such as a recognition ratio, an error rate and cross-entropy, to the hyper-parameter candidate generator 112 of the manager 11.

A description will now be given of processing of searching for hyper-parameter combinations.

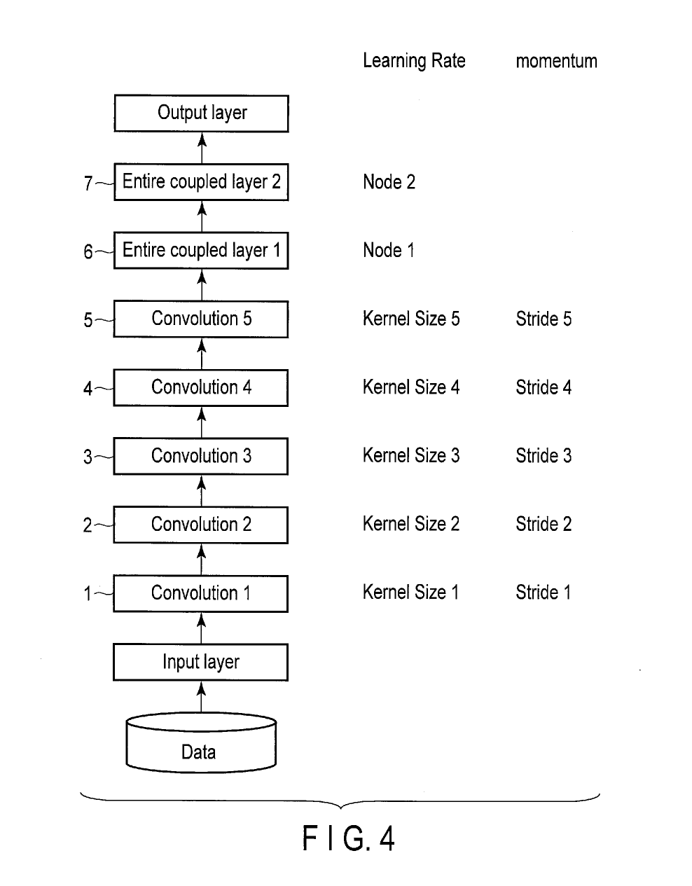

FIG. 4 shows the structure of a deep neural network, and the types of hyper-parameters processed by the respective layers of the deep neural network. In the deep neural network, if the number of network layers is small, and there are three types of hyper-parameters, each of which can assume three values, the combinations of the hyper-parameters is 3³=27. However, if the number of layers of the deep neural network is 7 as shown in FIG. 4, and each hyper-parameter can assume three values, the combinations of the hyper-parameters is 3⁷=2,187. Supposing that one hour is required for one-time learning of this deep neural network, 2,187 hours (about 91 days) are required for obtaining an optimal combination. Thus, it is very difficult to obtain the optimal combination.

In light of the above, the server system of the embodiment is made to have a cluster structure comprising one server 11 called a manager, and a plurality of servers 12-i called workers, thereby realizing an efficient and fast search for an optimal combination of hyper-parameters.

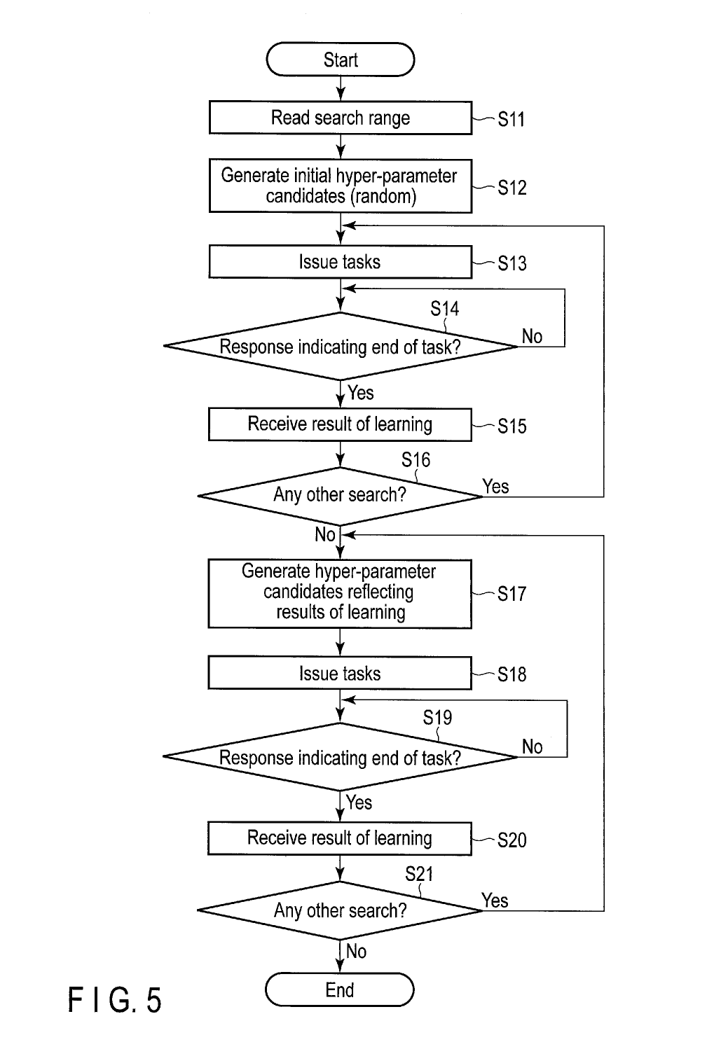

FIG. 5 is a flowchart showing processing performed by the above-mentioned manager 11. First, when start of a search shown in FIG. 5 is instructed, a search range is read from the hyper-parameter search range storage unit 111 (step S11), and a plurality of initial hyper-parameter candidates are generated within the search range (step S12). Since this candidate generation is an initial value search, the random system is adopted. Generated candidates are issued as tasks to arbitrary workers 12-i to instruct them to perform learning (step S13), and the end of the tasks is waited for (step S14). Upon receiving a response indicating the end of a task from each worker 12-i, the manager receives a result of learning from the same (step S15). If another search remains, the program returns to step S13, where the manager re-issues tasks (step S16).

In contrast, if there is no other search, subsequent hyper-parameter candidates that reflect the results of learning collected in the steps up to step S16 are generated (step S17). Since past search results are prepared for candidate generation at this time, the Bayesian method is adopted. Generated candidates are issued as tasks to arbitrary workers 12-i to instruct them to perform learning (step S18), and the end of the tasks is waited for (step S19). Upon receiving a response indicating the end of a task from each worker 12-i, the manager receives therefrom a result of learning (step S20). If another search remains, the program returns to step S17, where the manager re-issues tasks (step S21). In contrast, if there is no other search, this processing is finished.

Considering that hyper-parameters of good performance may not be detected by the Bayesian method because of initial value dependency, a random search is performed first, and a subsequent search is performed using the Bayesian method. As a result, efficient searching that utilizes the advantages of the respective methods is realized.

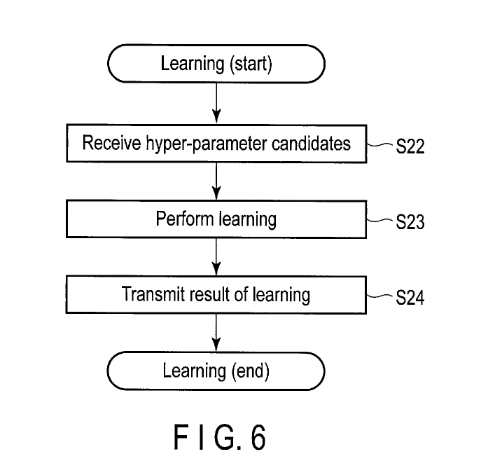

FIG. 6 is a flowchart showing processing performed by each worker 12-i. First, a task associated with a hyper-parameter candidate is received from the manager 11 (step S22), then learning based on the received task is performed (step S23), and the result of learning is transmitted to the manager 11 (step S24). The result of learning is an index representing performance, such as a recognition ratio, an error rate or cross-entropy.

The above-mentioned procedure enables a hyper-parameter for deep learning to be efficiently searched for.

A description will now be given of examples of the above-described embodiment for realizing further promotion of efficiency.

### EXAMPLE 1

In hyper-parameter search for deep learning that utilizes a neural network, it is common practice to perform searching while changing only the value of a hyper-parameter in a fixed neural network. However, it may be more efficient to perform searching while changing the number of layers of the neural network, instead of changing only the hyper-parameter value.

To search for the number of layers, the hyper-parameter candidate generator 112 of the manager 11 generates a parameter indicating a changed number of layers. If the number of nodes in a certain layer of the neural network is zero, this layer is considered not to exist. When the number of nodes in a certain layer of the neural network is zero, each worker 12-i performs learning assuming that the neural network does not have the layer, and transmits the result of learning to the manager 11. Thus, searching with the number of layers changed can be executed.

### EXAMPLE 2

It is known that deep learning utilizing a neural network requires a long learning period, since in this method, the performance of learning is enhanced by performing learning with the same data repeatedly input a few dozen times or more. In the case of a good-performance hyper-parameter, it is meaningful to enhance the performance with the same data repeatedly input a few dozen times. However, in the case of a low-performance hyper-parameter, even if this parameter is input a few dozen times for learning, it is not reflected in the learning, with the result that the time used for this processing will be wasted. In view of this, each worker 12-i monitors an index, such as a recognition ratio, during learning, interrupts learning when a hyper-parameter being used for learning is determined to be low in performance, and transmits, to the manager 11, the result of learning assumed when it is interrupted. It is supposed, as described above, that an index to be monitored during learning and to be transmitted to the manager 11 is, for example, a recognition ratio, an error ratio or cross-entropy.

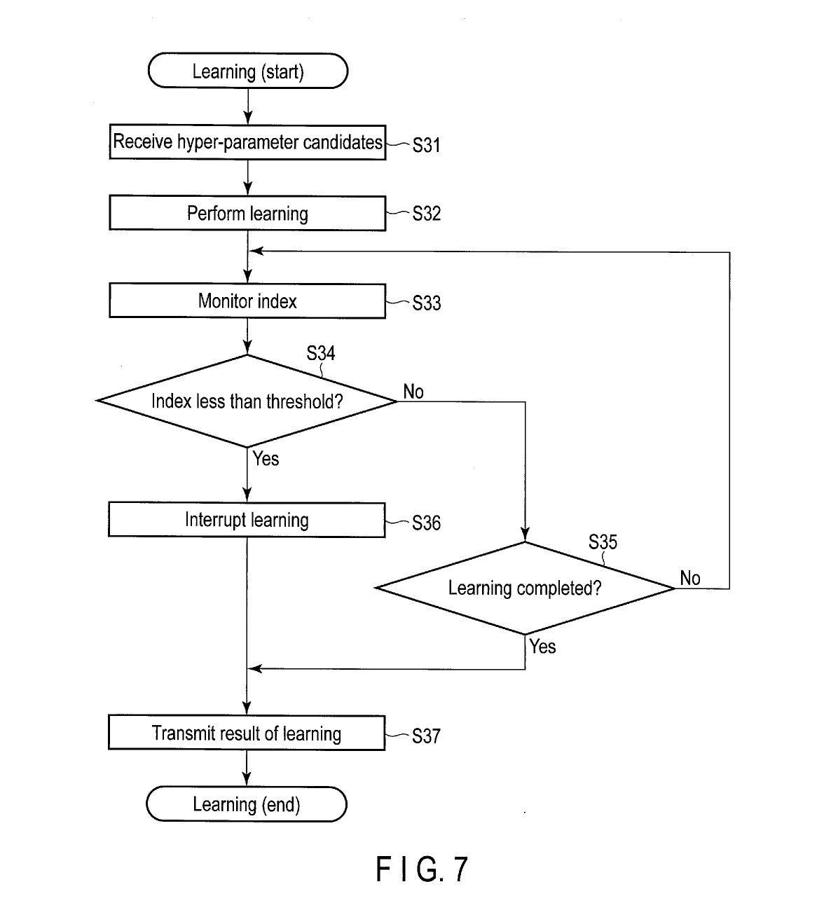

A specific example is shown in FIG. 7. FIG. 7 is a flowchart showing processing performed by each worker 12-i when it has an interrupt processing function. First, a task associated with a hyper-parameter candidate is received from the manager 11 (step S31), and then learning processing associated with the received task is performed (step S32). At this time, an index indicating the result of processing during learning is monitored (step S33), and it is determined whether the index is not greater than a threshold (step S34). If it is determined that the index is not greater than the threshold, monitoring of the index is continued until the learning is completed (step S35). If it is determined that the index is greater than the threshold, the learning is immediately interrupted (step S36). If it is determined in step S35 that the learning has been completed, or it is determined in step S36 that the learning has been interrupted, the result of learning (in the case of the interruption of learning, data indicating the interrupt and the result of learning assumed when the learning was interrupted) is transmitted to the manager 11 (step S37). As mentioned above, the result of learning is an index indicating performance that is assumed to be, for example, a recognition ratio, an error ratio or cross-entropy.

For example, if the number of repetitions of learning by each worker 12-i is 100, it is assumed that learning is interrupted when the recognition ratio is 90% or less after the learning is repeated 50 times, and is continued up to 100 times when the recognition ratio is greater than 90% after the learning is repeated 50 times. That is, if the recognition ratio is 93% with a high-performance hyper-parameter, learning is continued up to 100 times. In contrast, if learning is performed with a low-performance hyper-parameter, a recognition ratio of 85% is obtained after 50 times learning, the learning is interrupted at this point, instead of continuing the learning up to 100 times, and an index indicating the result of learning obtained when the learning was interrupted is transmitted to the manager 11. This can reduce wasted learning time to thereby enhance the efficiency of the entire processing.

In the above-mentioned example, although the recognition ratio is determined using a threshold of 90%, another determination method may be employed. For instance, learning may be interrupted when the recognition ratio is not increased even after learning is repeated ten times, or when the inclination of a learning curve becomes a predetermined value or less.

By virtue of the above-described processing, in the case of a low-performance hyper-parameter, learning can be interrupted to omit wasted learning time, thereby enabling efficient hyper-parameter searching.

### EXAMPLE 3

It is known that deep learning utilizing a neural network requires a long learning period. In order to shorten the learning period, the amount of learning data used by each worker 12-i during learning may be halved.

### EXAMPLE 4

In deep learning utilizing the neural network, an initial value for weighting is generated at random. The performance of learning will slightly vary depending upon the initial value. Because of this, each worker 12-i may perform learning with the weighting initial value changed a number of times, and may transmit, to the manager 11, an index indicating an average result of learning. This enables hyper-parameter searching to be performed stably.

### EXAMPLE 5

In deep learning utilizing the neural network, an initial weight is generated at random. Because of the randomly generated weight, a slight performance difference may occur. In this case, the same performance may not be obtained even after learning is repeated using the same hyper-parameter. In light of this, each worker 12-i may store a model (a result of deep learning) of the highest performance, and sends it to the manager 11, along with the result of learning.

### EXAMPLE 6

In deep learning utilizing the neural network, the performance is enhanced by performing learning using the same data repeatedly input a few dozen times or more. In this case, however, such an index of a learning result as recognition performance may be degraded because of excessive learning resulting from a predetermined number or more of repetitions of learning. In light of this, each worker 12-i may monitor such an index of a learning result as recognition performance each time it performs learning using data input once, and may store a model (a result of deep learning) of the highest performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server configured to construct a neural network for performing deep learning, and to search for parameters defining a learning operation, the server, a second server and a third server included in a system, the server also configured to:
specify, from a search range of the parameters, a first combination of first initial parameters and a second combination of second initial parameters, using a search method based on a uniform distribution;
transmit the first combination of first initial parameters to the second server;
transmit the second combination of second initial parameters to the third server;
receive, from the second server, a first learning result based on the first combination of the first initial parameters;
receive, from the third server, a second learning result based on the second combination of the second initial parameters;
specify, from the search range of the parameters, a third combination of third parameters, based on the first and second learning results and using a search method based on a probability distribution;
transmit the third combination of the third parameters to the second or third server; and
receive, from the second or third server, a third learning result based on the third combination of the third parameters.

2. The server of claim 1, wherein
the search method based on the uniform distribution is a random method; and
the search method based on the probability distribution is a Bayesian method.

3. The server of claim 1, further configured to
transmit, to the second server, data indicating a first number of layers of the neural network, along with the third combination of third parameters;
transmit, to the third server, data indicating a second number of layers of the neural network different from the first number, along with the third combination of third parameters;
receive, from the second server, a fourth learning result based on the third combination of third parameters, and the first number of layers of the neural network; and
receive, from the third server, a fifth learning result based on the third combination of third parameters, and the second number of layers of the neural network.

4. A system comprising the server, the second server and the third server recited in claim 1, wherein when an index of a learning result is less than a second threshold although the number of times of learning using the third combination of third parameters is greater than a first threshold, learning using the third combination of third parameters is interrupted, and a result of the interrupted learning is transmitted as a sixth learning result to the server.

5. A system comprising the server, the second server and the third server recited in claim 1, wherein the second server stores a model wherein an index of a learning result is not less than a third threshold.

6. A method for use in a server configured to construct a neural network for performing deep learning, and to search for parameters defining a learning operation, the server, a second server and third server included in a system, the method comprising:
specifying, from a search range of the parameters, a first combination of first initial parameters and a second combination of second initial parameters, using a search method based on a uniform distribution;
transmitting the first combination of first initial parameters to the second server;
transmitting the second combination of second initial parameters to the third server;
receiving, from the second server, a first learning result based on the first combination of the first initial parameters;
receiving, from the third server, a second learning result based on the second combination of the second initial parameters;
specifying, from the search range of the parameters, a third combination of third parameters, based on the first and second learning results and using a search method based on a probability distribution;
transmitting the third combination of the third parameters to the second or third server; and
receiving, from the second or third server, a third learning result based on the third combination of the third parameters.

7. The method of claim 6, wherein
the search method based on the uniform distribution is a random method; and
the search method based on the probability distribution is a Bayesian method.

8. The method of claim 6, further comprising:
transmitting, to the second server, data indicating a first number of layers of the neural network, along with the third combination of third parameters;
transmitting, to the third server, data indicating a second number of layers of the neural network different from the first number, along with the third combination of third parameters;
receiving, from the second server, a fourth learning result based on the third combination of third parameters, and the first number of layers of the neural network; and
receiving, from the third server, a fifth learning result based on the third combination of third parameters, and the second number of layers of the neural network.

9. A search method for use in a system including the server, the second server and the third server recited in claim 1, comprising interrupting learning using the third combination of third parameters, and transmitting, to the server, a result of the interrupted learning as a sixth learning result, when an index of a learning result is less than a second threshold although the number of times of learning using the third combination of third parameters is greater than a first threshold.

10. A search method for use in a system including the server, the second server and the third server recited in claim 1, comprising storing, in the second server, a model wherein an index of a learning result is not less than a third threshold.
